(19) United States
(12) Patent Application Publication
(10) Pub. No.: US 2014/0149341 A1
(43) Pub. Date: May 29, 2014

(54) SYSTEM AND METHOD FOR REFINING ADDRESS DATABASE FOR IMPROVING PERFORMANCE OF AUTOMATED MAIL SORTING MACHINE

(71) Applicant: Electronics and Telecommunications Research Institute, Daejeon (KR)

(72) Inventors: Hyon Gook KIM, Daejeon (KR); Seong Joon LEE, Daejeon (KR); Seon Hwa JEONG, Daejeon (KR); Hoon JUNG, Daejeon (KR)

(73) Assignee: Electronics and Telecommunications Research Institute, Daejeon (KR)

(21) Appl. No.: 13/964,381

(22) Filed: Aug. 12, 2013

(30) Foreign Application Priority Data
Nov. 29, 2012 (KR) 10-2012-0136673

(51) Int. Cl. G06F 17/30

(52) U.S. Cl. CPC G06F 17/30345
USPC 707/609

(57) ABSTRACT

A system for refining an address database for improving performance of an automated mail sorting machine includes: a UI control unit receiving data regarding an address database from the outside; a manual refining unit modifying a field value of the address database based on the received data; and an automated refining unit updating the address database to be connected with a delivery point address modified by modifying a data field of a lot number address or a road name address with respect to an error which occurs when converting address information of a delivery point into a unique code by using the address database.

### CROSS-REFERENCE TO RELATED APPLICATIONS

This application claims priority to and the benefit of Korean Patent Application No. 10-2012-0136673 filed in the Korean Intellectual Property Office on Nov. 29, 2012, the entire contents of which are incorporated herein by reference.

### TECHNICAL FIELD

The present invention relates to a system and a method for refining an address database, and more particularly, to a system and a method for refining an address database for improving performance of an automated mail sorting machine based on image recognition.

### BACKGROUND ART

During an automated mail sorting process, a database in which address information of a delivery destination is coded and stored in order to automatically sort a mail is called an address database.

Coding is a process that automatically recognizes an address character and compares the recognized address character with the address database to convert the address character into a unique code called a delivery point code.

In general, an address actually written on the mail may be different from the aforementioned address information of the address database.

Since transformation and omission are reflected on the address to be written depending on a person who sends the mail, the address database should information on the delivery destination address which is variously written.

Therefore, a Korean general address system needs to be standardized and recorded in the database in order to analyze an address character string acquired from the mail through image recognition and acquire the unique code.

The address database may be constituted by basic administrative districts such as si, do, gu, gun, dong, eup, myeon, ri, daero, ro, gil, and the like, main delivery points such as a house number, a building number, and the like, detailed delivery points such as a complex/number of an apartment or a building which is not sorted as the main delivery point, and a synonym and a keyword for recognizing an address written in various patterns as the same delivery point code.

As described above, in order to more accurately construct the address database, a method for improving refining performance of an automated mail sorting machine by refining the address database required for a process of coding the address written on the mail into the delivery point code through mail image recognition is required.

### SUMMARY OF THE INVENTION

The present invention has been made in an effort to provide a refining system that can organize added synonym data, reduce a missorting phenomenon of an automated mail machine, which is caused by a change of an address system, addition of a new address and a synonym, and the like, such as a data duplication problem which occurs due to matching of an address administrative district and main delivery point data dualised and stored to accept mail writing patterns which are representative by a lot number address and a road name address, and a data reference integrity problem which occurs at the time of modifying existing address data due to merging of administrative districts, a change of an address, and the like, and improve performance of an automated machine by refining an address database, in order to recognize an actual address written in various forms.

An exemplary embodiment of the present invention provides a system for refining an address database for improving performance of an automated mail sorting machine, including: a UI: control unit receiving data regarding an address database from the outside; a manual refining unit modifying a field value of the address database based on the received data; and an automated refining unit updating the address database to be connected with a delivery point address modified by modifying a data field of a lot number address or a road name address with respect to an error which occurs when converting address information of a delivery point into a unique code by using the address database.

The address database may include lot number address data, road name address data, and additional address information data, and the lot number address data may include lot number address administrative district data which is address data sorted by hierarchical administrative districts, lot number address main delivery point data which is address data of a delivery spot given by the unit of a house number, and lot number address detailed delivery point data which is address data indicating a more detailed delivery spot than the house number unit, the road name address data may include road name address administrative district data indicating a road name other than a higher administrative district and road name address main delivery point data which is a building number corresponding to a road section which contacts a main entrance of a delivery destination building, and the additional address information data may include synonym data storing the same name or keyword data corresponding to not a simple place name but a meaningful character.

The automated refining unit may further include an address name organizing unit determining whether the administrative district, the main delivery point, and the detailed delivery point data are duplicated, whether keyword data is omitted, or effectiveness of a keyword data type.

The automated refining unit may further include a road name address organizing unit giving a road name number to a road name address administrative district, and the road name address organizing unit may add a data field to match the added data field with one same road name number in the same road name expressed by different road name address administrative district records when the same road extends through a plurality of administrative districts in giving the road name number, and connect the road name number with the synonym data to integrally update the synonym for the same road name.

The automated refining unit may further include a main delivery point organizing unit giving a group number to the lot number address main delivery point and the road name address main delivery point, and the main delivery point organizing unit may redefine respective data by adding the data field and giving the group number to commonly connect information on the detailed delivery point regardless of the main delivery point when a plurality of buildings is connected to a single lot number or a single building is connected to a plurality of lot numbers.

The automated refining unit may further include a synonym organizing unit performing a function to redefine a road name number or a main delivery point group number which is newly given with respect to an existing synonym.

The automated refining unit may further include a keyword organizing unit modifying or deleting a keyword wrongly given depending on a type of the lot number address or road name address or a keyword which is not used.

The automated refining unit may further include a reference integrity checking unit performing reference integrity checking among data of an administrative district, a main delivery point, and a detailed delivery point of a lot number address and a road name address.

The refining system may further include: a database control unit connected with the address database to modify data of the address database; an image input unit receiving mail image data acquired from an automated mail sorting machine; an image processing unit acquiring an address character string from the received image and coding address information of a delivery destination; a performance analyzing unit determining whether to succeed in performing the coding and performing statistics processing; and a refining control unit controlling the address refining unit including the UI control unit, a manual refining unit, and an automated refining unit based on the address character string of an image that fails to convert coding of the delivery destination in accordance with a result of the performance analysis.

The refining system may be connected with the address database and thereafter, may automatically refine the address database by using the automated refining unit and manually refine refining items which are not automatically solved by using the manual refining unit.

When the automated mail sorting machine receiving the address database refined by the refining system fails to sort the mail due to misrecognition of the mail, the refining system may perform a performance analysis process to determine items to be additionally refined through image processing of extracting an address character string by receiving the image of the mail from the automated machine and converting coding of the delivery destination and repeatedly perform a process of refining the address database with respect to the refining items determined through the performance analysis process.

Another exemplary embodiment of the present invention provides a method for refining an address database for improving performance of an automated mail sorting machine, including: receiving data regarding an address database from the outside; modifying a field value of the address database based on the received data; and updating the address database to be connected with a delivery point address modified by modifying a data field of a lot number address or a road name address with respect to an error which occurs when converting address information of a delivery point into a unique code by using the address database.

The automated refining may further include giving a road name number to a road name address administrative district stored in the address database, and in the road name address organizing, a data field is added to the same road name expressed by different road name address administrative district records to match the added data field with one same road name number when the same road extends through a plurality of administrative districts in giving the road name number and the road name number is connected with the synonym data stored in the address database to integrally update the synonym for the same road name.

The automated refining may further include giving a group number to a lot number address main delivery point and a road name address main delivery point stored in the address database, and in the main delivery point organizing, respective data is redefined by adding the data field and giving the group number to commonly connect information on the detailed delivery point regardless of the main delivery point when a plurality of buildings is connected to a single lot number or a single building is connected to a plurality of lot numbers.

According to exemplary embodiments of the present invention, when an address database used in an existing automated mail sorting machine is refined through a system and a method for refining an address database for improving performance of an automated mail sorting machine, since a link relationship between data which may cause a mail to be missorted in existing address data can be modified and additional address information for absorbing a newly added delivery point and a mailing address written in various forms can be processed, mail sorting performance of the automated machine can be improved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a table illustrating several examples of a lot number address and a road name address stored in an address database.

FIG. 2 is an exemplary diagram illustrating a road name used at the time of expressing a road name address and a building number corresponding to a road section.

FIG. 3 is a flowchart illustrating a method for refining an address database for improving performance of an automated mail sorting machine according to an exemplary embodiment of the present invention.

FIG. 4 is a conceptual diagram illustrating a structure of an address database used in an exemplary embodiment of the present invention.

FIG. 5 is a functional block diagram illustrating a structure of a system for refining an address database according to an exemplary embodiment of the present invention.

FIG. 6 is a functional block diagram illustrating, in more detail, a structure of an address refining unit according to an exemplary embodiment of the present invention.

FIG. 7 is a flowchart for describing an address database refining process which is performed among an automated machine, an address database refining system, and an address database according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings such that those skilled in the art can easily implement the exemplary embodiments. However, the present invention may be implemented in various different forms and the present invention is not limited to exemplary embodiments described below. Parts which are not associated with the description are not illustrated in the drawings in order to clearly describe the present invention and like reference numerals refer to like elements throughout the specification.

Throughout the specification, when a predetermined part “includes” a predetermined component, it is understood that if it is not contrarily described, the part may further include other components and not exclude the other components.

When reference numerals refer to components of each drawing, it is noted that although the same components are illustrated in different drawings, the same components are referred to by the same reference numerals as possible. In describing the present invention, when it is determined that the detailed description of the known art related to the present invention may obscure the gist of the present invention, the detailed description thereof will be omitted.

In describing the components of the present invention, terms such as first, second, A, B, (a), (b), and the like may be used. The terms are used to just distinguish the component from other components and the essence, sequence, or order of the corresponding component is not limited by the terms. When it is described that any component is “connected”, “coupled”, or “linked” to other components, it should be understood that the component may be directly connected or linked to other components, but another component may be “connected”, “coupled”, or “linked” between the respective components.

The present invention relates to a system for refining an address database that improves performance of an automated mail sorting machine by refining the address database with respect to the address database for converting an address character string extracted based on image recognition obtained in the automated mail sorting machine into a delivery point code.

The present invention proposes a system for refining an address database that provides a UI capable of modifying contents on an administrative district, a main delivery point, and a detailed delivery point in an address database including a lot number address, a road name address, and additional address information and has an address refining function as a main function to provide functions such as matching organization of an address name, the lot number address, and the road name address, reference integrity check, and the like.

Hereinafter, a system for refining an address database of the present invention will be described in detail with reference to various drawings.

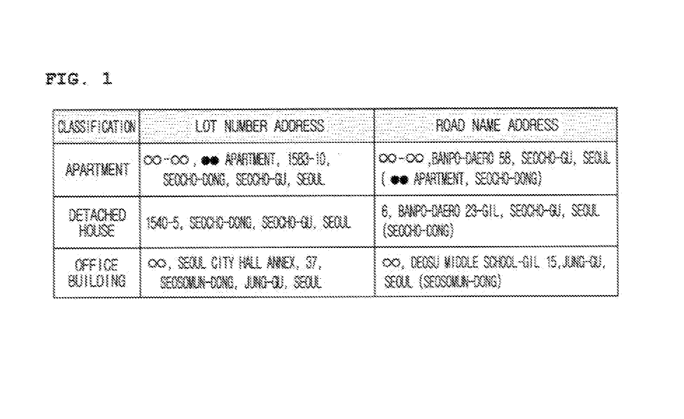

FIG. 1 is a table illustrating several examples of a lot number address and a road name address stored in an address database.

At present, Korea has a dualised address system. The dualised address system includes the lot number address used from old times and a newly used road name address.

It can be found that the road name address which is a new address has the same head part as the lot number address which is used up to now. The reason is that up to <Si, Gun, Gu (+Eup, Myeon)> are just written next to <Si, Do>.

However, a road name and a building number are written instead of Dong and a stress address or Ri. Next thereto, as a detailed address, a comma (,) is put in, and Dong and the number of an apartment are written.

An apartment house name such as an apartment is not written as the new address. The reason is that an apartment name may be excessively long or the apartment name may be changed. However, until the new address is established, a reference item may be added to the last end of the address by using a parenthesis.

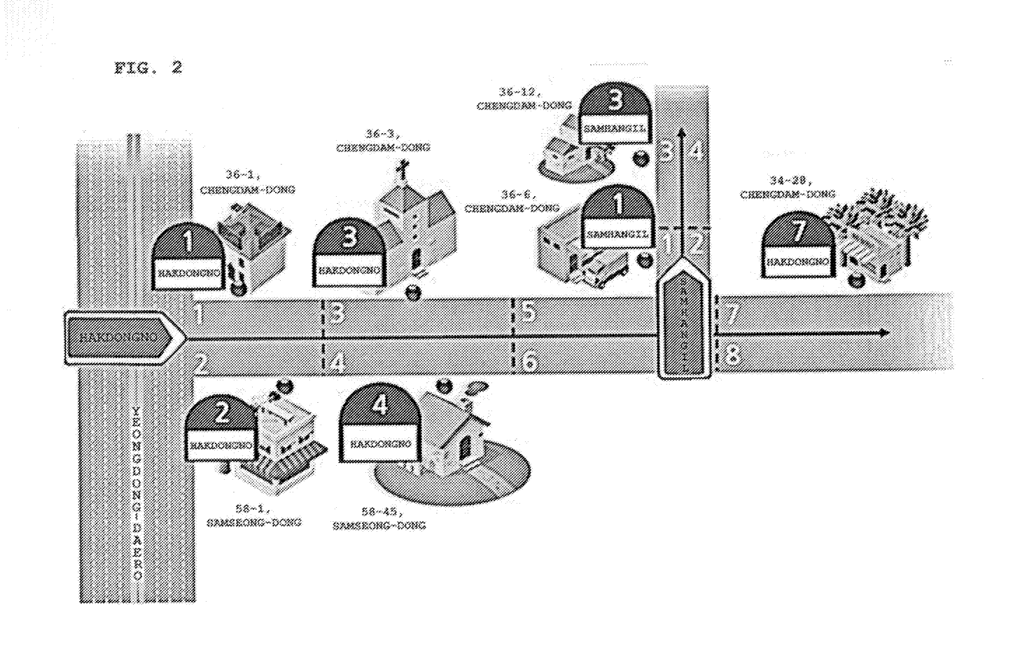

FIG. 2 is an exemplary diagram illustrating a road name used at the time of expressing a road name address and a building number corresponding to a road section.

In the road name address which is the new address, simple mathematical wisdom is used to classify a road and a building.

First, the road name ends with daero, ro, or gil. A road having a width which is more than 40 m or eight or more lanes of both incoming and outgoing traffic is written as a <daero>. Examples of the daero include a Sejong-daero or a Yeongdong-daero. A road which is smaller than the daero but has a width more than 12 m or two or more lanes of both incoming and outgoing traffic is written as a <road>. Jungangno or Hakdongno corresponds to the road.

The building number is given based on a road which meets a front gate (main entrance) of the building. A base number given every 20 m section in a direction from a start point to an end point of the road is used.

In this case, the number increases from the west to the east and from the south to the north. Since an odd number is given to a building at a left side of the road and an even number is given to a building at a right side of the road toward the east or the north, a numeral increases by 2 every 20 m.

If several buildings are present in one section, a branch number is added from a second building. For example, if three buildings are present in section No. 2, a first building is just written as 2, a second building is written as 2-1, and a third building is written as 2-2.

Other roads are designated by the name of a <gil> such as Myeongju-gil or Hannarae-gil. When a small road is branched from a large road, the small road may be named like <Banpo-daero 23-gil> by using a numeral together with the name of the large road.

In this case, an odd number is given to a road branched to the left of the large road and an even number is given to a road branched to the right side of the large road based on a progress direction of the road. For example, Banpo-daero 23-gil means a small road branched to the left from Banpo-daero.

As described above, a conventional lot number address and a new road name address have been simply described. Hereinafter, the system for refining an address database for improving performance of an automated mail sorting machine according to the present invention will be described in earnest.

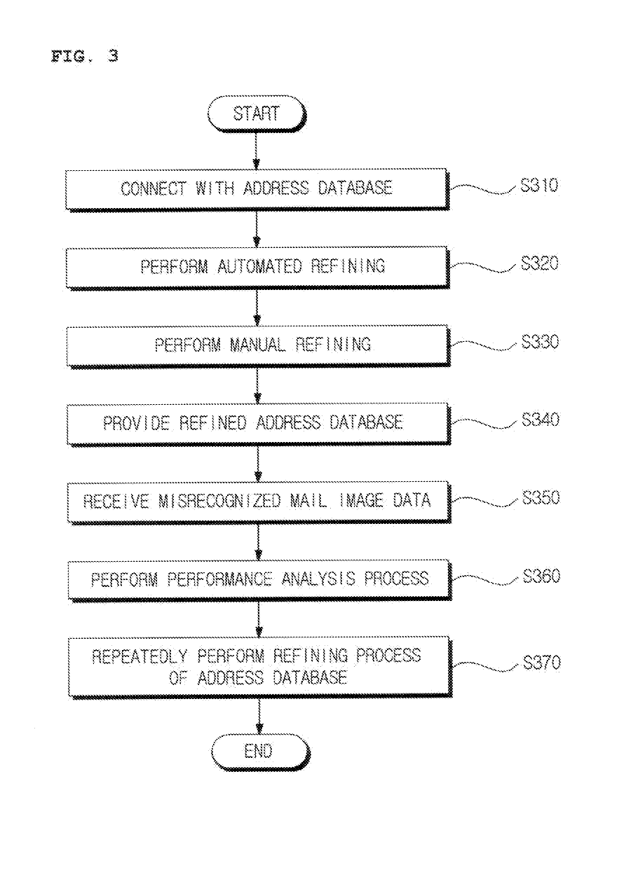

FIG. 3 is a flowchart illustrating a method for refining an address database for improving performance of an automated mail sorting machine according to an exemplary embodiment of the present invention.

The method for refining an address database for improving performance of an automated mail sorting machine according to an exemplary embodiment of the present invention generally includes a manual refining step of modifying a field value of the address database by receiving data on the address database from the outside and an automatic refining step of updating the address database to be connected with a delivery point address modified by modifying a data field of a lot number address or a road name address with respect to an error which occurs when converting address information of a delivery point into a unique code by using the address database.

The relationship of the system for refining an address database and the automated mail sorting machine, and the address database during the refining will be described below. As illustrated in FIG. 3, the system for refining an address database is first connected with the address database (S310) and automatically refines the address database (S320).

Step S320 is automatically performed by the refining system. A refining item which cannot be automatically solved from step S320 is manually refined by using the refining system (S330).

After the refining is completed, the automated machine provides the address database so as to be used to sort a mail (S340).

Thereafter, when the automated machine does not succeed in sorting the mail by misrecognizing a mail delivery point address or failing to recognize the mail delivery point address, an image of the mail is provided to the refining system (S350).

The refining system extracts an address character string through the mail image and performs a performance analyzing process of determining an item to be additionally refined through an image processing process of performing a delivery point coding process (S360).

The refining system refines the address database by repeatedly performing steps S310 to S330 with respect to the determined refining item (S370).

In this case, the automatic refining step may further include a road name address organizing step of giving a road name number to a road name address administrative district stored in the address database, as a principal function during the refining process by the refining system, and in this case, when giving the road name number, if the same road extends throughout a plurality of administrative districts, a data field is added to the same road name expressed by different road name address administrative district records to match one same road name number and connect the same road name with synonym data stored in the address database to integrally update a synonym of the same road name.

The automatic refining step may further include a main delivery point organizing step of giving a group number to a lot number address main delivery point and a road name address main delivery point stored in the address database, and in the main delivery point organizing step, when a plurality of buildings is connected to a single lot number or a single building is connected to a plurality of lot number numbers, respective data is redefined by adding the data field and giving the group number to process the respective data to be commonly connected with detailed delivery point information regardless of the main delivery point or not.

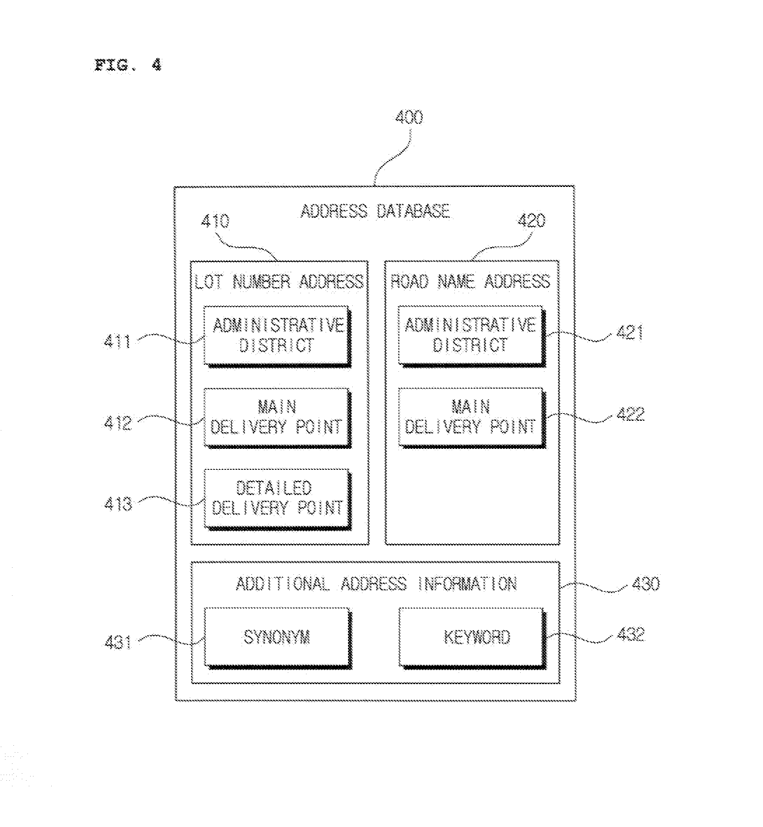

FIG. 4 is a conceptual diagram illustrating a structure of an address database used in an exemplary embodiment of the present invention.

Referring to FIG. 4, an address database 400 includes lot number address 410 data sorted by a house number address with respect to administrative districts such as si, do, gu, gun, dong, eup, myeon, ri, and the like, a road name address 420 sorted by road name addresses such as daero, ro, gil and the like, and additional address information 430 data for recognizing various writing patterns.

The lot number address 410 data includes lot number address administrative district 411 data storing a hierarchical administrative district, a lot number address main delivery point 412 storing a delivery point granted by the unit of the house number, and a lot number address detailed delivery point 413 storing a detailed delivery point which is not expressed by the house number.

The road name address 420 data includes a road name address administrative district 421 storing road names such as daero, ro, gil, and the like other than an upper administrative district and a base number given at an interval of 20 m, and a road name address main delivery point 422 storing a building number corresponding to a road section which contacts a main entrance of a building.

The additional address information 430 includes synonym 431 data for storing several names indicating the same region, the same institute, or the same building or a keyword 432 which is not a simple region name among characters or words shown in the address and has a particular meaning but can be omitted by a rule or has information which is variously written.

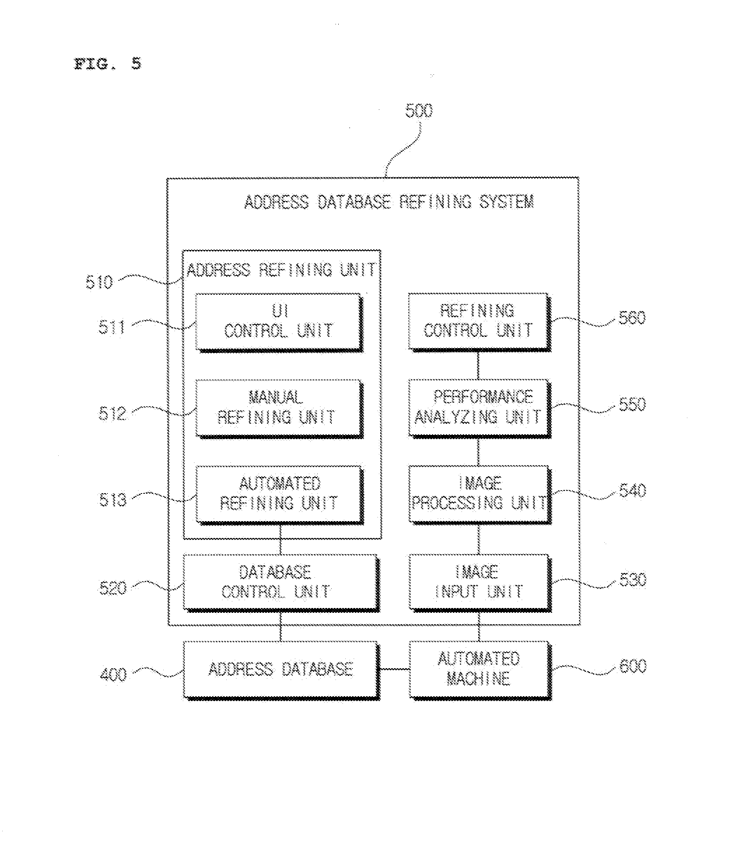

FIG. 5 is a functional block diagram illustrating a structure of a system for refining an address database according to an exemplary embodiment of the present invention.

Referring to FIG. 5, an address database refining system 500 may include an address refining unit 510 including a UI control unit 511, a manual refining unit 512, an automated refining unit 513 and a database control unit 520 for connection with the address database 400 and for modifying the data of the address database 400.

The address database refining system 500 may include an image input unit 530 receiving a mail image acquired from an automated machine 600 and an image processing unit 540 acquiring an address character string from the received image and processing coding into a delivery point code.

The address database refining system 500 may include a performance analyzing unit 550 determining whether to succeed in performing the delivery point coding and performing statistics processing and a refining control unit 560 that can control the address refining unit 510 based on an address character string of an image which fails to convert the delivery point code through performance analysis.

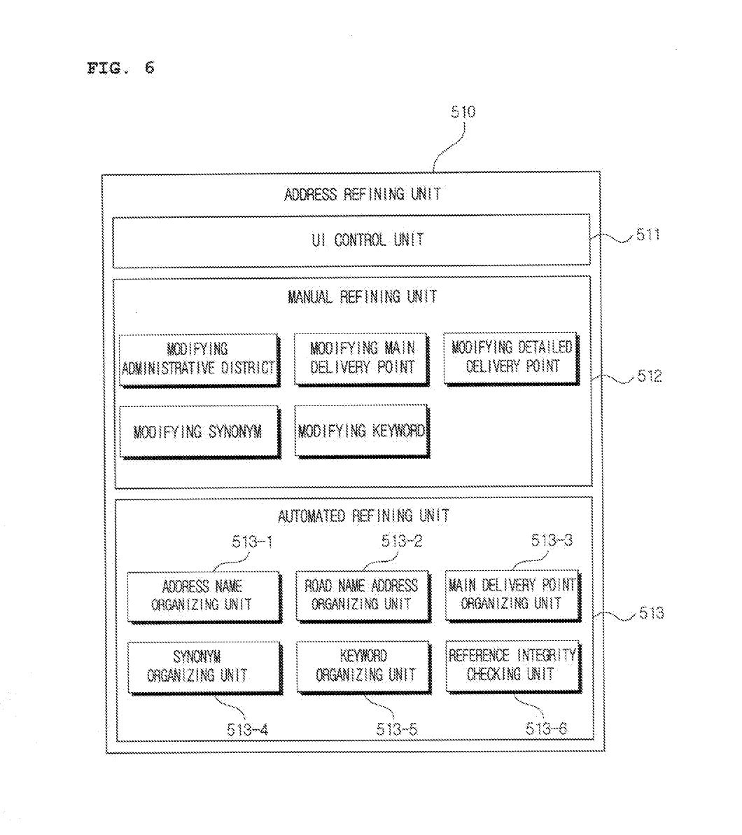

FIG. 6 is a functional block diagram illustrating, in more detail, a structure of an address refining unit according to an exemplary embodiment of the present invention.

The address refining unit 510 illustrated in FIG. 6 is a main unit that performs address refining which is a core function of the address database refining system.

The address refining unit 510 includes a UI control unit 511 providing a UI that allows a user to input and modify information, a manual refining unit 512 modifying an administrative district, a main delivery point, a detailed delivery point, a synonym, and keyword data based on the received information, and an automated refining unit 513 performing more complicated and various organization functions.

First, the automated refining unit 513 includes an address name organizing unit 513-1 organizing whether the administrative district, the main delivery point, and the detailed delivery point are duplicated, whether the keyword is omitted, effectiveness of a keyword type, and the like, a road name address organizing unit 513-2 giving a road name number to a road name address administrative district, and a main delivery point organizing unit 513-3 giving a group number to the lot number address main delivery point and the road name address main delivery point.

The automated refining unit 513 further includes a synonym organizing unit 513-4 performing a function to redefine a road name number and a main delivery point group number which are newly given to the existing synonym, a keyword organizing unit 513-5 organizing a keyword wrongly given depending on an address type or a keyword which is not used, and a reference integrity checking unit 513-6 performing a reference integrity checking function among data of a lot number address and a road name address, and an administrative district, a main delivery point, and a detailed delivery point.

Meanwhile, a detailed algorithm for the main functions constituting the automated refining unit 513 of FIG. 6 will be described below.

The road name address organizing unit 513-2 adds a data field to the same road name expressed by different road name address administrative district records, which match one road name number and connects the road name number with the synonym 431 to integrally update the synonym for the same road name when the same road extends through several lot number address administrative districts 411 in giving the road name number to the road name address administrative district 421.

The main delivery point organizing unit 513-3 respectively redefines corresponding data by adding the data field and giving the group number to commonly connect information on the detailed delivery point 413 regardless of the main delivery point 412 of the lot number address or the main delivery point 422 of the road name address even when a lot number and a building number do not correspond to each other one to one and a plurality of buildings is connected to a single lot number or a single building is connected to a plurality of lot numbers.

Meanwhile, the synonym organizing unit 513-4 performs processing of defining a name group number to group data using the same name and connecting the defined name group number with the synonym 431 in addition to connecting the road name number given by the road name address organizing unit 513-2 or the group number given by the main delivery point organizing unit 513-3 with the synonym 431.

By indicating a case in which a synonym 431 of an administrative district name, a main delivery point name, and a detailed delivery point name that belong to a specific administrative district are duplicatively used, the user verifies the case through the manual refining unit 512 to determine whether the names are reflected.

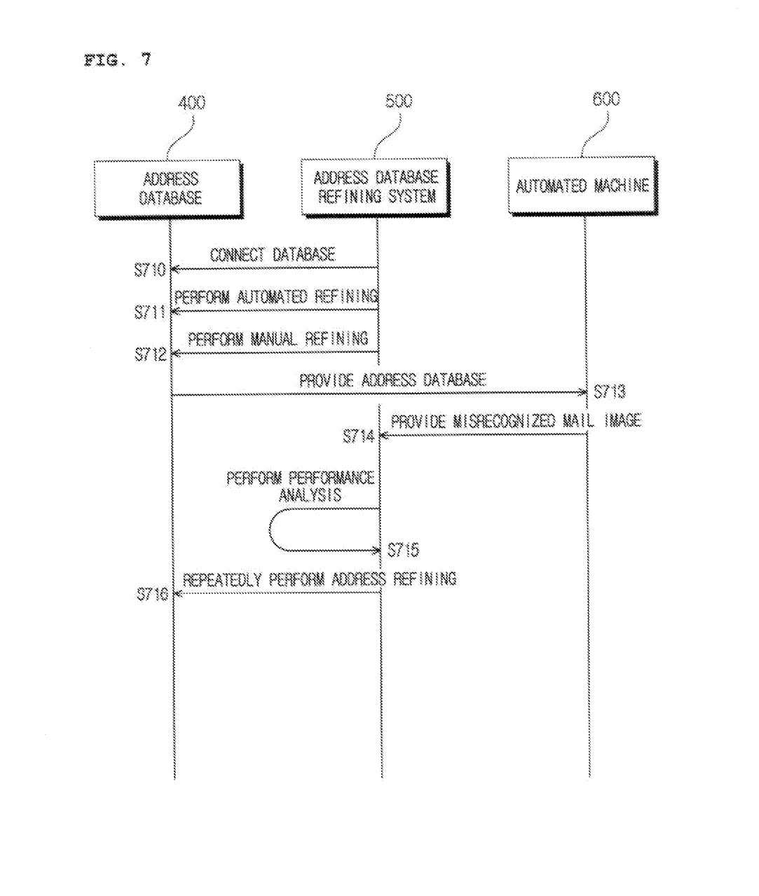

FIG. 7 is a flowchart for describing an address database refining process which is performed among an automated machine, an address database refining system, and an address database according to an exemplary embodiment of the present invention.

Referring to FIG. 7, the address database refining system 500 is first connected with the address database 400 (S710).

Thereafter, the refining system 500 automatically refines the address database 400 (S711). The automated refining process is automatically performed by the refining system 500.

However, refining items which cannot be automatically solved may be complementarily manually refined by using the refining system 500 (S712).

The address database 400 provides the address database which the automated machine uses to sort the mail to the automated machine (S713).

When the automated machine 600 fails to sort the mail due to misrecognition, the automated machine 600 provides an image of the failed mail to the refining system 500 (S714).

The refining system 500 extracts an address character string through the mail image and performs a performance analyzing step of determining an item to be additionally refined through an image processing step of performing a coding process into a delivery point code (S715).

The refining system 500 repeatedly performs the database connection (S710), the automatic refining (S711), and the manual refining (S712) which are performed in advance with respect to the refining items determined through the performance analyzing process to refine the address database 400 (S716).

When the address database used in the existing automated mail sorting machine is refined by using the address database refining method according to the present invention, a link relationship between data and data, which may cause the mail to be missorted in the existing address data may be modified, and additional address information for absorbing the newly added delivery points and variously written mailing addresses may be processed, so that mail sorting performance of the automated machine may be improved.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A system for refining an address database for improving performance of an automated mail sorting machine, comprising:
a UI control unit receiving data regarding an address database from the outside;
a manual refining unit modifying a field value of the address database based on the received data; and
an automated refining unit updating the address database to be connected with a delivery point address modified by modifying a data field of a lot number address or a road name address with respect to an error which occurs when converting address information of a delivery point into a unique code by using the address database.

2. The system of claim 1, wherein:
the address database includes lot number address data, road name address data, and additional address information data,
the lot number address data includes lot number address administrative district data which is address data sorted by hierarchical administrative districts, lot number address main delivery point data which is address data of a delivery spot given by the unit of a house number, and lot number address detailed delivery point data which is address data indicating a more detailed delivery spot than the house number unit,
the road name address data includes road name address administrative district data indicating a road name other than a higher administrative district and road name address main delivery point data which is a building number corresponding to a road section which contacts a main entrance of a delivery destination building, and
the additional address information data includes synonym data storing the same name or keyword data corresponding to not a simple place name but a meaningful character.

3. The system of claim 2, wherein:
the automated refining unit further includes an address name organizing unit determining whether data of the administrative district, the main delivery point, and the detailed delivery point are duplicated, whether the keyword data is omitted, or effectiveness of a keyword data type.

4. The system of claim 2, wherein:
the automated refining unit further includes a road name address organizing unit giving a road name number to the road name address administrative district, and
the road name address organizing unit adds a data field to match the added data field with one road name number in the same road name expressed by different road name address administrative district records when the same road extends through a plurality of administrative districts in giving the road name number, and connects the road name number with the synonym data to integrally update the synonym for the same road name.

5. The system of claim 2, wherein:
the automated refining unit further includes a main delivery point organizing unit giving a group number to the lot number address main delivery point and the road name address main delivery point, and
the main delivery point organizing unit respectively redefines the respective data by adding the data field and giving the group number by adding the data field and giving the group number to commonly connect information on the detailed delivery point regardless of the main delivery point when a plurality of buildings is connected to a single lot number or a single building is connected to a plurality of lot numbers.

6. The system of claim 4, wherein:
the automated refining unit further includes a synonym organizing unit performing a function to redefine a road name number or a main delivery point group number which is newly given with respect to an existing synonym.

7. The system of claim 5, wherein:
the automated refining unit further includes a synonym organizing unit performing a function to redefine a road name number or a main delivery point group number which is newly given with respect to an existing synonym.

8. The system of claim 2, wherein:
the automated refining unit further includes a keyword organizing unit modifying or deleting a keyword wrongly given depending on a type of the lot number address or road name address or a keyword which is not used.

9. The system of claim 2, wherein:
the automated refining unit further includes a reference integrity checking unit performing reference integrity checking among data of the administrative district, the main delivery point, and the detailed delivery point of the lot number address and the road name address.

10. The system of claim 1, wherein:
the refining system further includes:
a database control unit connected with the address database to modify data of the address database;
an image input unit receiving mail image data acquired from an automated mail sorting machine;
an image processing unit acquiring an address character string from the received image and coding address information of a delivery destination;
a performance analyzing unit determining whether to succeed in performing the coding and performing statistics processing; and
a refining control unit controlling the address refining unit including the UI control unit, a manual refining unit, and an automated refining unit based on the address character string of an image that fails to convert coding of the delivery destination in accordance with a result of the performance analysis.

11. The system of claim 10, wherein:
the refining system is connected with the address database and thereafter,
automatically refines the address database by using the automated refining unit, and
manually refines refining items which are not automatically solved by using the manual refining unit.

12. The system of claim 11, wherein:
when the automated mail sorting machine receiving the address database refined by the refining system fails to sort the mail due to misrecognition of the mail,
the refining system performs a performance analysis process to determine items to be additionally refined through image processing of extracting an address character string by receiving the image of the mail from the automated machine and converting coding of the delivery destination and
repeatedly performs a process of refining the address database with respect to the refining items determined through the performance analysis process.

13. A method for refining an address database for improving performance of an automated mail sorting machine, comprising:
receiving data regarding an address database from the outside;
modifying a field value of the address database based on the received data; and
updating the address database to be connected with a delivery point address modified by modifying a data field of a lot number address or a road name address with respect to an error which occurs when converting address information of a delivery point into a unique code by using the address database.

14. The method of claim 13, wherein:
the automated refining further includes giving a road name number to a road name address administrative district stored in the address database,
wherein in the road name address organizing, a data field is added to the same road name expressed by different road name address administrative district records to match the added data field with one same road name number when the same road extends through a plurality of administrative districts in giving the road name number and the road name number is connected with the synonym data stored in the address database to integrally update the synonym for the same road name.

15. The method of claim 13, wherein:
the automated refining further includes:
giving a group number to a lot number address main delivery point and a road name address main delivery point stored in the address database, and
in the main delivery point organizing, respective data are redefined by adding the data field and giving the group number to commonly connect information on the detailed delivery point regardless of the main delivery point when a plurality of buildings is connected to a single lot number or a single building is connected to a plurality of lot numbers.
